(19) United States
(12) Patent Application Publication
(10) Pub. No.: US 2008/0030618 A1
(43) Pub. Date: Feb. 7, 2008

(54) Content Receiving Apparatus, Content Receiving Method, And Content Distributing System

(76) Inventors: Ryuichi Okamoto, Osaka (JP); Motoji Ohmori, Osaka (JP); Yoshikatsu Ito, Osaka (JP); Toshihisa Nakano, Osaka (JP)

Correspondence Address: WENDEROTH, LIND & PONACK L.L.P., 2033 K. STREET, NW, SUITE 800, WASHINGTON, DC, 20006, US

(21) Appl. No.: 11/664,520

(22) PCT Filed: Oct. 21, 2005
(86) PCT No.: PCT/JP05/19367

§ 371 Date: Apr. 3, 2007

(30) Foreign Application Priority Data
Oct. 21, 2004 (JP) 2004-307280

(51) Int. Cl. H04N 5/44

(52) U.S. Cl. 348/553

(57) ABSTRACT

[Object] To realize a content receiving apparatus and the like which can avoid a situation where content cannot be reproduced even when content receiving routes are switched from a broadcast wave to a communication network at an arbitrary timing.

[Means to achieve the object] A receiving route switch control unit (112) determinates which receiving route is selected from the broadcast wave (20) and the communication network (30) to obtain content, and switches receiving routes based on this determination. A DRM module (140) manages the copyright of the obtained content based on a digital rights management (DRM) method defined by a provider A when content is received via the broadcast wave (20). Likewise, a DRM module (150) manages the content of copyright based on a DRM method B defined by a provider B, and a DRM module (160) manages content copyrights based on a DRM method C defined by a provider C, respectively.

### TECHNICAL FIELD

The present invention relates to an apparatus which receives broadcast content in television broadcasting, and in particular relates to an apparatus which receives, via a communication network, content identical to that provided by a broadcast wave, in the case where it is difficult to receive the content from the broadcast wave.

### BACKGROUND ART

In addition to analogue television broadcasting, “Digital terrestrial television broadcasting” has partially begun to be implemented. This digital terrestrial television broadcasting is provided using available analogue television channels. The frequency band of one channel is divided into 13 segments; the content details to be transmitted in each segment and the information amount of the content to be transmitted can be set separately. Additionally, multiplexed signals, including television broadcasting, plural units of audio, data, and the like, can be transmitted through one channel, and thus a variety of services can be provided.

Moreover, implementation of digital terrestrial television broadcasting in mobile terminals as typified by mobile phones is being planned. In this case, one-segment broadcasting which uses a segment of one channel, can be considered.

However, unlike a conventional stationary receiver, the above-mentioned mobile terminal is often used by a user who is moving on foot or in a car. Therefore, there is the possibility that television broadcasting cannot be received or clear pictures and audio cannot be obtained indoors, underground, or behind buildings where the electric field intensity of electric wave is small.

A conceivable method to solve the above-mentioned problem is to receive content identical to that of television broadcasting via a wireless LAN in areas where broadcast waves are difficult to be received (See Patent Reference 1, for example).

FIG. 1 is an external view of a content distributing system 1500 which allows the receiving of broadcast content via wireless LAN in the area where broadcast waves are difficult to be received. As shown in FIG. 1, when the user moves from a broadcast wave receivable area 1510 to a broadcast wave hardly-receivable area 1520, the content distributing system 1500 switches content receiving routes for a user terminal according to a reception status. Patent Reference 1: Japanese Laid-Open Patent Application No. 2003-274214

### DISCLOSURE OF INVENTION

### Problem that the Invention is to Solve

However, broadcast content provided through digital terrestrial television broadcasting is expected to include content encrypted based on broadcast content copyright protection. In addition, the copyright of content distributed via a wireless LAN may be protected through, for example, an encryption system unique to wireless LAN. Therefore, in this case, even if the user terminal has a broadcasting Digital Rights Management (DRM) module and a license to reproduce the broadcast content, content obtained via wireless LAN cannot be reproduced.

FIG. 2 is a diagram illustrating problems in the above-mentioned conventional system, and shows a typical case where content obtained via a communication network cannot be reproduced because the content protection method is different, even if the DRM module and the license compliant with broadcast content are included in the user terminal. As shown in FIG. 2, the broadcasting DRM module allows reproduction of content obtained via a broadcast wave because the module has a license for the content obtained via a broadcast wave, but the module cannot handle content obtained via a communication network and the content cannot be reproduced. Moreover, there is a problem that the conventional system cannot handle storage-type broadcasting (server-based broadcasting), either.

Having been concerned in light of the above-mentioned problems, an object of the present invention is to realize a content receiving apparatus which can avoid a situation where content cannot be reproduced if the content receiving route is switched from a broadcast wave to a communication network at an arbitrary timing.

### Means to Solve the Problems

To achieve the above-mentioned purpose, a content receiving apparatus according to the present invention includes a first receiving unit which receives broadcast content via a broadcast wave and a second receiving unit which receives communication content identical to the broadcast content via a communication network. The apparatus includes a first judgment unit which judges whether or not switching from the first receiving unit to the second receiving unit is appropriate; an availability judgment unit which judges whether or not the communication content is available when the switching to the second receiving unit is performed; and a receiving route switch unit which switches content receiving routes from the first receiving unit to the second receiving unit when the first judgment unit judges that the switching is appropriate and the availability judgment unit judges that the communication content is available.

This allows avoiding a situation where content cannot be reproduced if the content receiving route is switched from a broadcast wave to a communication network at an arbitrary timing.

The first judgment unit may judge that the switching is appropriate when the electric field intensity of the broadcast wave falls to a certain level or below.

The first judgment unit may further judge that the switching is appropriate when the usage fee of the communication content is lower than a usage fee of the broadcast content.

The first judgment unit may further judge that the switching is appropriate when information which is different from the information added to the broadcast content is added to the communication content.

The availability judgment unit may judge that the switching is possible when a license compliant with the communication content is available.

The content receiving apparatus further may include a holding unit which holds the license compliant with the communication content. The availability judgment unit may further judge whether or not the license held by the holding unit is valid. The receiving route switch unit may switch content receiving routes from the first receiving unit to the second receiving unit when the first unit judges that the switching is appropriate and the availability judgment unit judges that the communication content is available.

The content receiving unit may further include: an information collection unit which collects pieces of information on the receiving of the communication content via the broadcast wave and the communication network; an information presentation unit which presents the collected information to a user; and an operation acceptance unit which accepts the selection of a piece of information among the presented pieces of information. The first judgment unit may judge that the switching based on the accepted information is appropriate.

The first judgment unit may make the judgment based on the termination time of the broadcast content, and the receiving route switch unit may switch the receiving routes using address information regarding a website included in the broadcast content. The website is connected to the communication network and provides the communication content.

The first receiving unit may receive broadcast content encrypted by a first copyright protection method. The second receiving unit may receive communication content encrypted by a second copyright protection method. The receiving route switch unit may switch the content receiving routes and the copyright protection methods from the first receiving unit to the second receiving unit when the first judgment unit judges that the switching is appropriate and the availability judgment unit judges that the communication content is available.

Moreover, the present invention can be realized as the content receiving method which includes the steps compliant with unique configuration units in the above-mentioned content receiving apparatus and as a program causing a personal computer and the like to execute these steps. Obviously, the program can be widely distributed via storage media such as DVDs and transmission media such as the Internet and the like.

### EFFECTS OF THE INVENTION

As described above, the content distributing system according to the present invention allows avoiding a situation where content cannot be reproduced if the content receiving route is switched from a broadcast wave to a communication network at an arbitrary timing. Additionally, the content distributing system has remarkable effects as mentioned above when copyright protection is provided for the content.

### BRIEF DESCRIPTION OF DRAWINGS

FIG. 1 is an external view of a conventional content distributing system which can receive content via a wireless LAN.

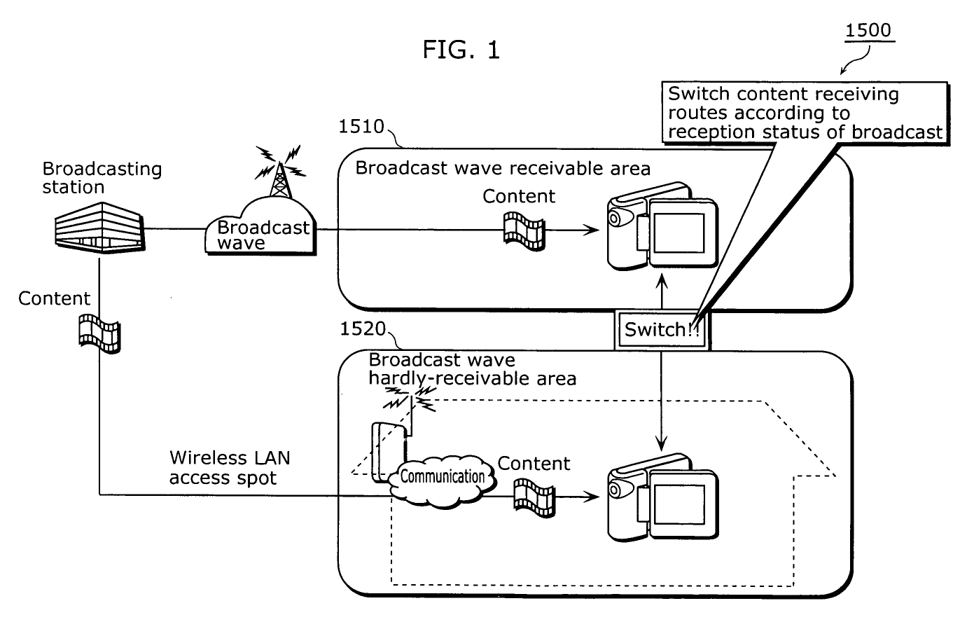

FIG. 2 is a diagram indicating a conventional problem when the content obtained via the communication network is reproduced.

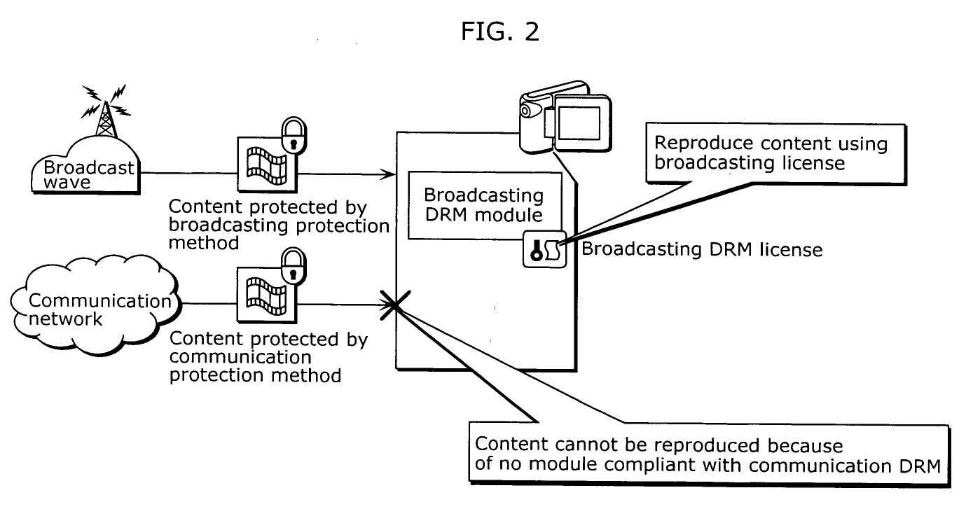

FIG. 3 is a diagram showing the general outline of the content distributing system in a first embodiment.

FIG. 4 is a diagram showing the content distributing form in a content distributing system according to the first embodiment.

FIG. 5 is a block diagram showing the functional configuration of a user terminal in the first embodiment.

FIG. 6 is a block diagram showing the functional configuration of the DRM module for the DRM method B in the first embodiment.

FIG. 7 is a diagram showing an example of the license data structure in the first embodiment.

FIG. 8 is a flow chart showing an operation flow of the user terminal in the first embodiment.

FIG. 9 is a flow chart showing a content provider determination process in FIG. 8.

FIG. 10 is a flow chart showing a content key obtainment process in FIG. 8.

FIG. 11 is an example of display on a switch indication screen in the first embodiment.

FIG. 12 is an example of broadcast content including the URL information in a second embodiment.

FIG. 13 is an external view of the content distributing system in a third embodiment.

FIG. 14 is a diagram showing the general outline of the content distributing system in the third embodiment.

FIG. 15 is a diagram showing the content distributing form in the content distributing system according to the third embodiment.

FIG. 16 is a block diagram showing the functional configuration of a home server in the third embodiment.

FIG. 17 is a block diagram showing the functional configuration of the user terminal in the third embodiment.

FIG. 18 is a block diagram showing the functional configuration of the DRM module for the home server in the third embodiment.

FIG. 19 is an example of display on a switch indication screen in the third embodiment.

### NUMERICAL REFERENCES

10, 11 Content distributing system
80 License ticket (LT)
100 User terminal
110 Overall control unit
111 Storage unit
112 Receiving route switch control unit
113 Content key obtainment unit
114 Content decryption unit
115 Content reproduction and output unit
116 Notification unit
120 Receiving control unit
130 Communication control unit
140 DRM module
150 DRM module
151, 561 Module control unit
152 License DB
153 License obtainment unit
154, 623 Availability judgment unit
155 Content key transmitting unit
156 Charging process unit
157 Viewing history management unit
160 DRM module
170 Operation input unit
180, 680 Local bus
200 DRM server
210 Content distributing server
300 DRM server
310 Content distributing server
400 DRM server
410 Content distributing server
500 User terminal
510, 1510 Broadcast wave receivable area
520, 1520 Broadcast wave hardly-receivable area
560 DRM module
562, 660 Authentication information storage unit
563, 631 Authentication unit
564, 670 Content key sharing unit
600 Home server
610 Server control unit
621 Content receiving unit
632 Content conversion unit
633 Content transmitting unit
640 Content storage unit
1500 Content distributing system

### BEST MODE FOR CARRYING OUT THE INVENTION

Embodiments according to the present invention are described in reference to diagrams as follows. Note that the present invention is described using the diagrams in the following embodiments, but the following embodiments are not intended to limit the present invention.

### FIRST EMBODIMENT

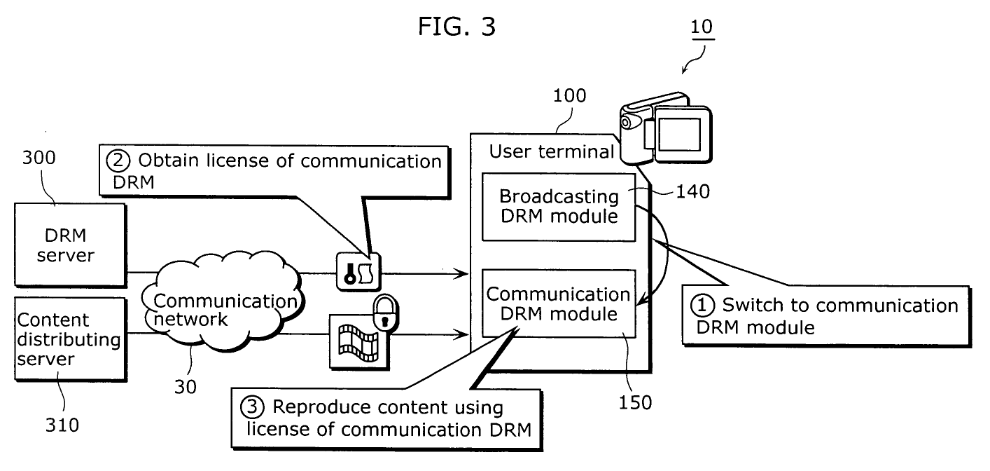

FIG. 3 is a diagram showing the general outline of a content distributing system 10 in the embodiment. As shown in FIG. 3, a user terminal 100 of the content distributing system 10 obtains content from a content distributing server 310 and information about a license for the above-mentioned content (the information includes a content key for decrypting content, hereinafter the information is simply referred to as a “license”) from a DRM server 300 via a communication network 30, respectively. Additionally, the user terminal 100 has a communication DRM module 150 for controlling the obtained content and information. This allows the switching of content receiving routes from the broadcast wave to a communication network 30. This also allows the obtaining of the license compliant with the content to be received via a communication network and the use of content (including reproduction, the same applies hereafter) by using this license. Specifically, the user terminal 100 (1) switches the control modules for content use from a broadcasting DRM module 140 to the communication DRM module 150 when the reception level of a broadcast wave is reduced to a certain level or below. Moreover, the user terminal 100 obtains (2) the communication DRM license necessary for the use of content obtained via the communication network 30. Accordingly, the user terminal 100 uses (3) content obtained via the communication network 30 using the obtained communication DRM license.

Here, the broadcasting Digital Rights Management (DRM) module is a unit for performing control related to reproduction restriction and the like in order to protect the copyright of digital content received via a broadcast wave. Likewise, the communication DRM module is a unit for performing control on copyright protection for digital content received via the communication network. Each module is configured with a ROM, which stores control programs, a dedicated processor, and the like.

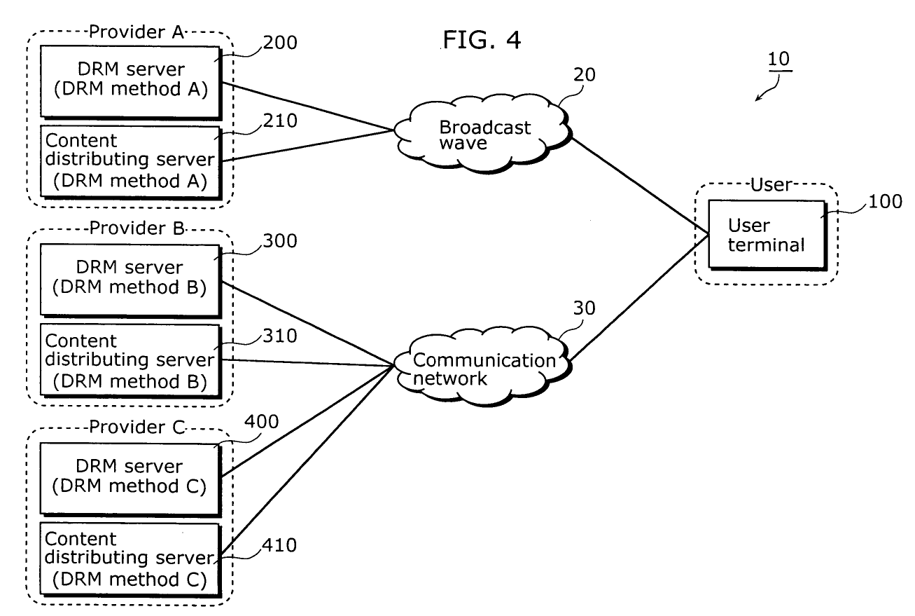

FIG. 4 is a diagram showing a content distributing form of the content distributing system according to the embodiment. As shown in FIG. 4, the user terminal 100 of the content distributing system 10 obtains (receives), via a broadcast wave 20, the license and content from a DRM server 200 and a content distributing server 210 of a provider A, while the user terminal 100 can obtain content from provider A and the same content from providers B or C at almost the same timing via the communication network 30 including the Internet.

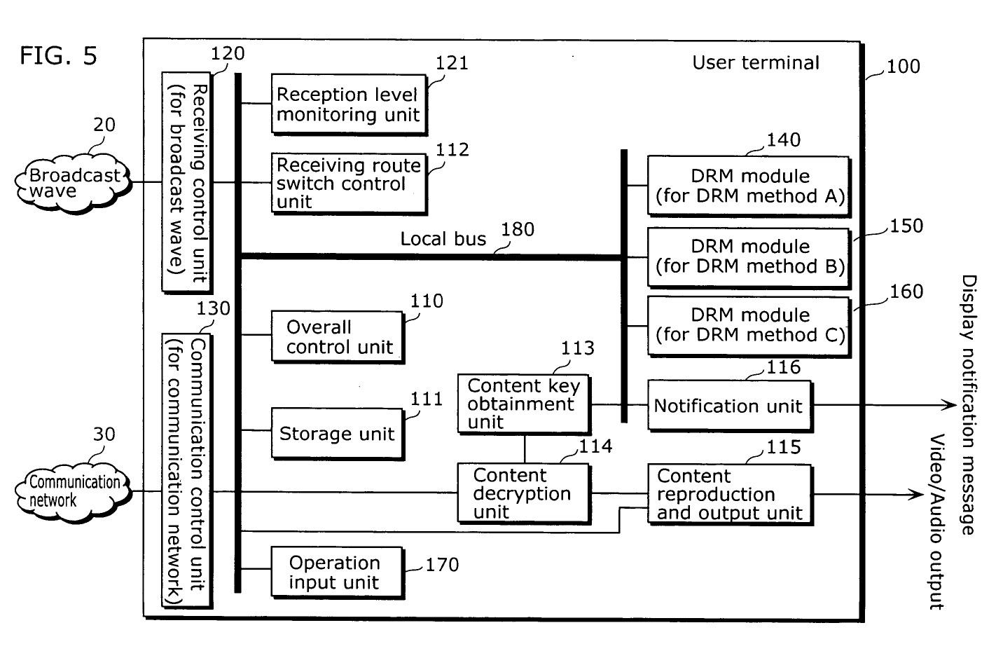

FIG. 5 is a block chart showing the functional configuration of the terminal 100 in the embodiment. As shown in FIG. 5, the user terminal 100 has an overall control unit 110, a storage unit 111, a receiving route switch control unit 112, a content key obtainment unit 113, a content decryption unit 114, a content reproduction and output unit 115, a notification unit 116, a receiving control unit 120, a communication control unit 130, the DRM module 140, the DRM module 150, a DRM module 160 and an operation input unit 170, each of which is connected by a local bus 180.

The overall control unit 110 is a CPU including ROM, RAM and the like. The overall control unit 110 controls the user terminal 100 entirely by causing the CPU to execute control programs stored in ROM and the like. Moreover, the overall control unit 110 collects information on the reception level of the currently being received electric wave and information on charging necessary at a content reproduction time in all transmitting routes (that is, receiving routes). Additionally, the overall control unit 110 judges whether or not the switch indication screen should be displayed in the content reproduction and output unit 115 (that is, it judges whether or not switching from the current receiving route to another receiving route is appropriate). The overall control unit 110 is an example of a first judgment unit and an information collection unit.

The storage unit 111 is a storage device such as RAM and the like, and stores content received via the broadcast wave 20 or the communication network 30.

According to an indication of the overall control unit 110, the receiving route switch control unit 112 decides between the broadcast wave 20 and the communication network 30 to be used as a receiving route to obtain content, and switches receiving routes based on this determination.

The content key obtainment unit 113 obtains a content key (also referred to as content decryption key) from the DRM module 140, the DRM module 150 or the DRM module 160, and transmits them to the content decryption unit 114.

The content decryption unit 114 decrypts content stored in the storage unit 111, using a content key received from the content key obtainment unit 113.

The content reproduction and output unit 115 includes a liquid crystal panel, a speaker, and the like, and presents content decrypted by the content decryption unit 114 and necessary information to the user. Additionally, the content reproduction and output unit 115 is an example of the information presentation unit.

The notification unit 116 includes a liquid crystal panel and a speaker, and transmits a message such as an error message to the user, when necessary.

The receiving control unit 120 performs various controls and data processing to receive content via the broadcast wave 20. This receiving control unit 120 is an example of a first receiving unit.

The communication control unit 130 performs various controls and data processing to receive content via the communication network 30. This communication control unit 130 is an example of a second receiving unit.

Note that the above-mentioned receiving control unit 120 and the communication control unit 130 are feasible with the conventional technology, and they are not an essential part of the present invention. Thus, a detailed description is omitted.

A receiving level monitoring unit 121 measures the electric field intensity of the electric wave which is received periodically (for example, at an interval of a second). If the electric field intensity falls below a predetermined level, the status is notified to the overall control unit 110.

When receiving content via the broadcast wave 20, the DRM module 140 manages the copyright of the obtained content based on the Digital Rights Management (Hereinafter referred to as the DRM method) defined by provider A. Likewise, the DRM module 150 manages the copyright of content based on the DRM method B defined by provider B and the DRM module 160 based on the DRM method C defined by provider C. Although the DRM module 140, the DRM module 150, and the DRM module 160 have been described as configuration elements of the user terminal 100, the configuration of the user terminal 100 is not limited to this configuration and all or some of these elements may be realized with secure and dedicated IC cards and the like.

The operation input unit 170 is configured with a keyboard and a mouse and the like, and receives a key entry and an indication from the user.

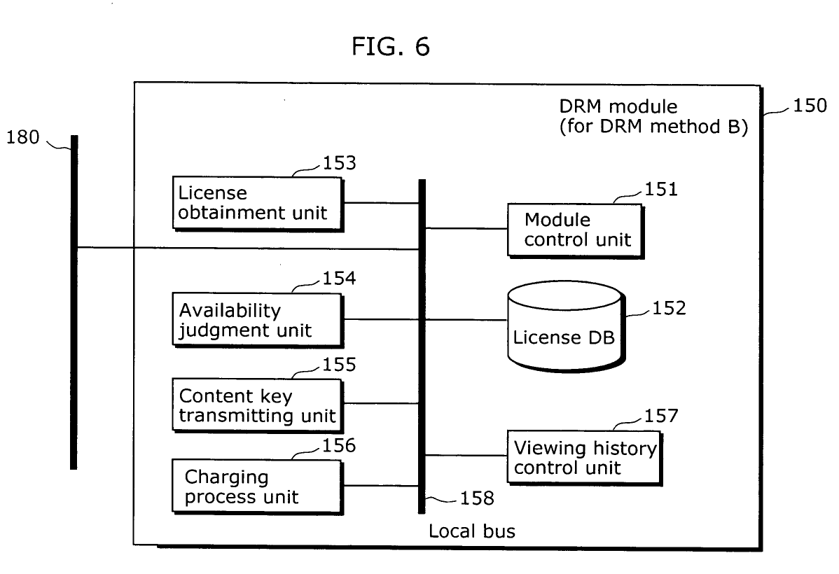

FIG. 6 is a block diagram showing a functional configuration in the DRM module 150. As shown in FIG. 6, the DRM module 150 includes a module control unit 151, a license DB 152, a license obtainment unit 153, an availability judgment unit 154, a content key transmitting unit 155, a charging process unit 156, and a viewing history management unit 157. The functional configuration of the DRM module 160 includes the same functional configuration as that of the above-mentioned DRM module 150. In addition, the functional configuration of the DRM module 140 is different in that a broadcast wave DRM is executed, but the basic functional configuration is the same as that of the above-mentioned DRM module 150. The module control unit 151 controls the entire DRM module 150 by the dedicated processor and the like.

The license DB 152 is a storage device such as RAM and holds a license (in this case, the DRM method B license) necessary for the use of content obtained by purchase or the like. A specific example of license is described later.

According to an indication of the module control unit 151, the license obtainment unit 153 obtains a license by purchase or the like for the content obtained via the communication network 30.

The availability judgment unit 154 judges whether or not the obtained content is available based on the obtained license.

The content key transmitting unit 155 transmits a content key for decrypting content to the content key obtainment unit 113 when the content is judged to be available in the availability judgment unit 154.

The charging process unit 156 performs the charging process according to the use form when content is used by the user.

A viewing history management unit 157 controls information indicating the content viewing history when content is viewed (including the case where the content is used) by the user.

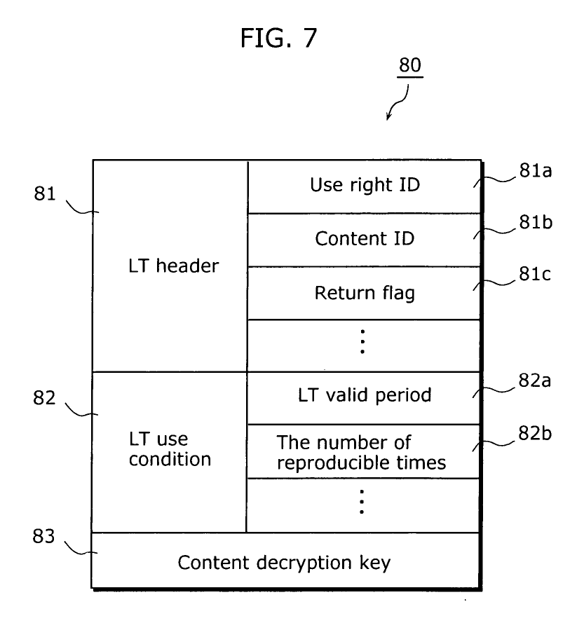

FIG. 7 is a diagram showing an example of the data structure of a license ticket (hereinafter referred to as “LT”) as a specific example of the license. As shown in FIG. 7, an LT 80 is configured with an LT header 81, an LT use condition 82, and a content decryption key 83.

The LT header 81 is configured with a use right ID 81a, a content ID 81b, and a return flag 81c.

The use right ID 81a stores an ID which uniquely identifies the LT 80. The content ID 81b stores the content ID of content which is available by using the LT 80. In the return flag 81c, information indicating if the LT 80 needs to be returned to the DRM server is described.

An LT use condition 82a is configured with an LT valid period 82a, and the number of reproducible times 82b.

The LT valid period 82a stores information indicating a valid period of the LT 80. The reproducible frequency 82b stores information indicating how many times the content can be reproduced (including the case where the content is used; the same applies hereafter.)

The content decryption key 83 is a decryption key for the decryption of content specified by the content ID 81b.

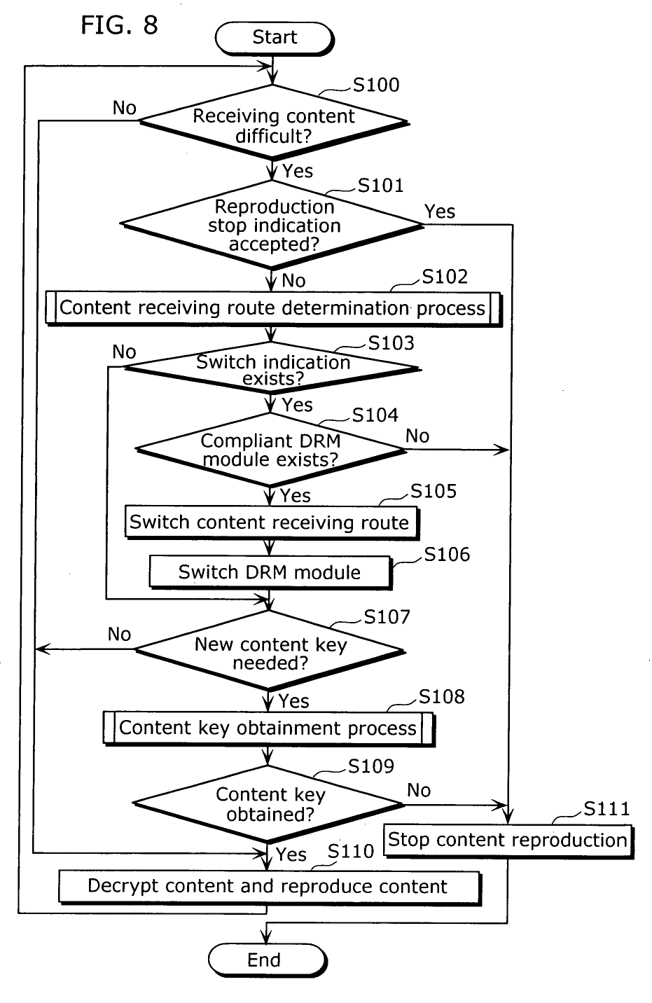

Next, the operation of the user terminal 100 configured as mentioned above is described. FIG. 8 is a flow chart showing the operation flow of the user terminal 100 in the embodiment. A description is provided for the following case. The radio field intensity decreased because the user moved into a building while receiving the predetermined content (for example, the broadcast content of a baseball game). However, content identical to the content which was received via the broadcast wave 20 is received by the receiving route which is switched by choosing a receiving route (for example, a wireless RAN) among the communication network 30 based on the predetermined regulations.

The receiving level monitoring unit 121 measures the electric field intensity of electric wave to be received periodically (for example, at an interval of a second) and transmits a notification to the overall control unit 110 when the strength falls below a predetermined level (S100: Yes). When receiving the above-mentioned notification from the receiving level monitoring unit 121, the overall control unit 110 directs the notification unit 116 to display the information that the electric field intensity of the electric wave is small.

Subsequently, when there is no indication of “reproduction stop” from the user via the operation input unit 170 (S101: No), the overall control unit 110 executes “the content provider determination process” (S102). On the other hand, when there is the indication of “reproduction stop” from the user (S101: Yes), the overall control unit 110 stops reproducing the content (S111) and terminates the process.

Moreover, when there is the switch indication of the content receiving routes from the user (S103: Yes) in the content provider determination process (S102), the overall control unit 110 checks when there is a DRM module indicated by the switch indication. When there is the compliant with DRM module (S104: Yes), the content receiving routes are switched based on the switch indication (S105), and switching to the DRM modules to be activated is performed (S106). When there is no switch indication (S103: No), the process proceeds to the process S107. Additionally, when there is no compliant with DRM module (S104: No), the process proceeds to the process S111.

Then, the newly switched DRM module checks when a new content key is necessary. When the new content key is necessary (S107: Yes), the content key obtainment process is executed (S108). Here, the case where a new content key is necessary is, for example, a case where content is encrypted by a time variable key.

When a new content key is not necessary (S107: No), the process proceeds to the process S110.

Next, when the overall control unit 110 can obtain a content key (S109: Yes) in the content key obtainment process (S108), it controls each unit to perform content decryption and reproduction (S110).

When the overall control unit 110 cannot obtain the content key in the content key obtainment process (S108) (S109: No), it stops reproducing the content (S111) and terminates the process.

The flow chart of FIG. 8 shows the embodiment where the content key obtainment process (S108) is executed after the content receiving route switching (S105) and the DRM module switching (S106) are performed. The content key obtainment process (S108) may also be performed when necessary after judging whether or not an available license is included before the content receiving route switching (S105) and the DRM module switching (S106) are performed.

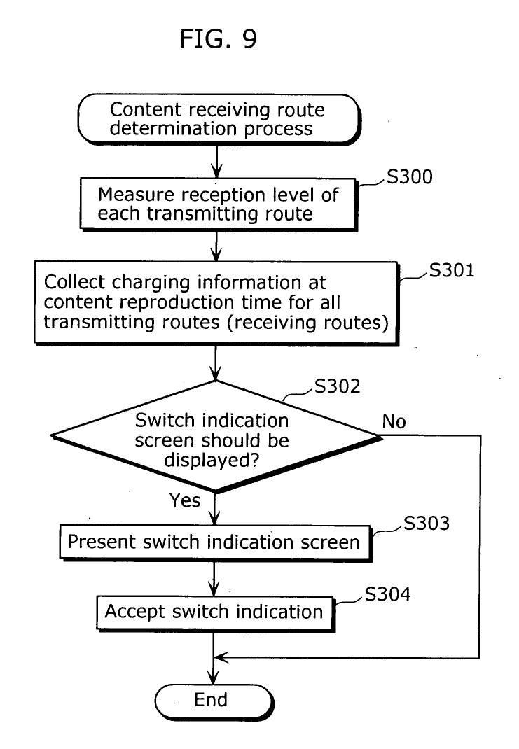

FIG. 9 is a flow chart showing the content provider determination process (S102) in FIG. 8.

First, the overall control unit 110 directs the receiving level monitoring unit 121 to measure reception levels on the respective receiving routes (S300).

Next, the overall control unit 110 collects information on charging necessary at a content reproduction time in all the transmitting routes (that is, receiving routes) (S301).

In addition, the overall control unit 110 judges whether or not the switch indication screen should be displayed in the content reproduction and output unit 115 (that is, judges whether or not switching from the current receiving route to other receiving route is appropriate) based on the information on the above-mentioned measurement results and charging (S302). Here, when it is judged that the switch screen should not be displayed (or its display is not necessary) (S302: No), the process is terminated.

Specific examples of criteria for judging whether or not the above-mentioned switch indication screen should be displayed include:

(1) the case where the reception level of the current content receiving route falls to a certain level or below, and another content receiving route, of which reception level is higher than the current content receiving route, exists;

(2) the case where there is a content provider which allows obtaining a license for content and a usage fee is lower than that of the current content provider (or a certain amount and below);

(3) the case where there is a content provider which distributes additional information (for example, audio information) that is different from the information added to the content which is currently being received. The above-mentioned judgment may be made based on one or a combination of the criteria.

Accordingly, the overall control unit 110 directs the content reproduction and output unit 115 to display the switch indication screen which shows a list of information on the receiving routes (S303). Moreover, the overall control unit 110 receives the indication on receiving route switching from the user (S304), and terminates the process.

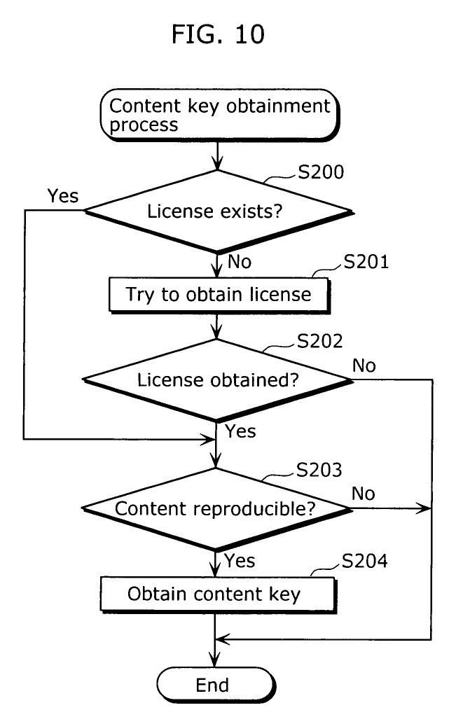

FIG. 10 is a flow chart showing the content key obtainment process (S108) in FIG. 8.

First, with reference to the license DB 152, the availability judgment unit 154 judges whether or not the license including the content key for content to be reproduced is included and whether or not the license is appropriate (for example, about an expiration date and the consumption status of a frequency license and the like) (S200). When the license DB 152 does not have the license (S200: No), the availability judgment unit 154 directs the license obtainment unit 153 to obtain the license via the communication network 30 (S201).

When the license can be obtained (S202: Yes), the availability judgment unit 154 judges whether or not the obtained license allows the use of content (S203). When the content is available (S203: Yes), the availability judgment unit 154 obtains the content key (which is, for example, attached to the obtained license) based on the license (S204).

When the license cannot be obtained (S202: No) and it is judged that content cannot be reproduced with the obtained license (S203), the process is terminated.

Moreover, when the license is already obtained (S200: Yes), the process proceeds directly to the process which judges whether or not content can be reproduced (S203).

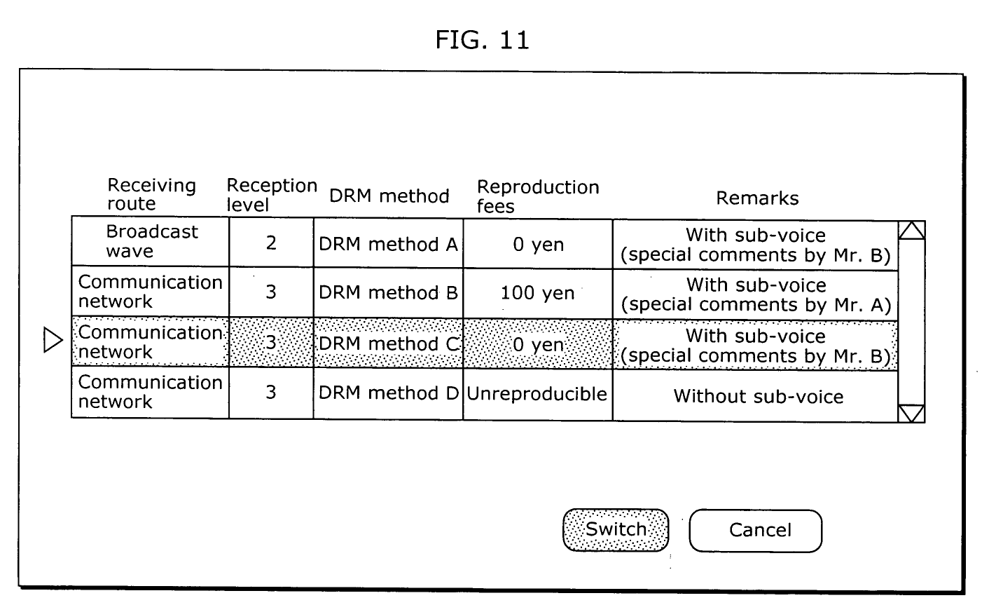

FIG. 11 is a display example of the switch indication screen in the content reproduction and output unit 115. The switch indication screen in FIG. 11 has the sections of “Receiving route”, “reception level”, “DRM method”, “Reproduction fees” and “Remarks”. The section of “Receiving route” displays a list of receiving forms (for example, “Broadcast wave”, “Communication network”) which are available for receiving content in the user terminal 100. The section of “reception level” displays the information indicating the strength of the reception levels (for example, numeric values such as “3”, “2” and “1” in the descending order of the reception level) based on the electric field intensity of electric wave and the like. The section of “DRM method” displays the DRM method types (for example, “DRM method B”) which are available in the user terminal 100. The section of “Reproduction fees” displays the information showing the usage fee for content (for example, “100 yen” or “Cannot be reproduced”). The section of “Remarks” displays the information on special privilege for the content use and content (for example, “with sub-voice (special comments by Mr. A)”) and the like via a certain receiving route.

Additionally, in the above-mentioned switch indication screen,

(1) the receiving route switch control unit 112 determines a receiving route to be recommended and highlights a text line showing the receiving route;

(2) the receiving route information may be displayed in descending order of recommendation (that is, the most recommended receiving route information is placed in the top of the list) so as to be user-friendly.

By allowing to specify the priority of parameters (for example, reception level/reproduction fees) for the preliminary switching of the receiving routes by the user, the receiving route to be recommended in the above-mentioned (1) and (2) may be determined based on this priority.

This allows the user to switch to a desirable receiving route in reference to the list of the switchable receiving routes.

### Second Embodiment

The above-mentioned first embodiment shows an example of switching the content receiving routes when prescribed conditions are met. However, this embodiment shows an example of adding, to a part of the received content, information indicating a receiving route to be switched for increasing the convenience of the content receiving route switching.

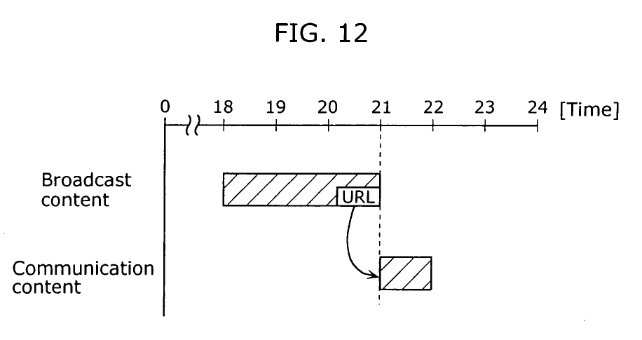

FIG. 12 is a diagram showing an example where the information which identifies a receiving route via a communication network is added to a part of content obtained using a broadcast wave. As shown in FIG. 12, for example, when the broadcast content of a baseball game which is being received via the broadcast wave 20 ends at 21:00, because the URL of an Internet site which provides the baseball game content after 21:00 is attached to a part of this broadcast content, a user can continuously obtain the baseball game content based on this URL.

Although the above-mentioned embodiment shows an example of switching the receiving route using a broadcast wave to the receiving route using a communication network, it is also possible to switch from the receiving route using a communication network to the receiving route using a broadcast wave.

### Third Embodiment

The first embodiment shows an example of switching content receiving routes from a broadcast wave to a communication network which is provided by a general provider. In addition to the content receiving routes in the first embodiment, this embodiment shows an example of receiving content via a broadcast wave by a home server installed in a home, and adding a receiving route for transmitting the content to a user terminal.

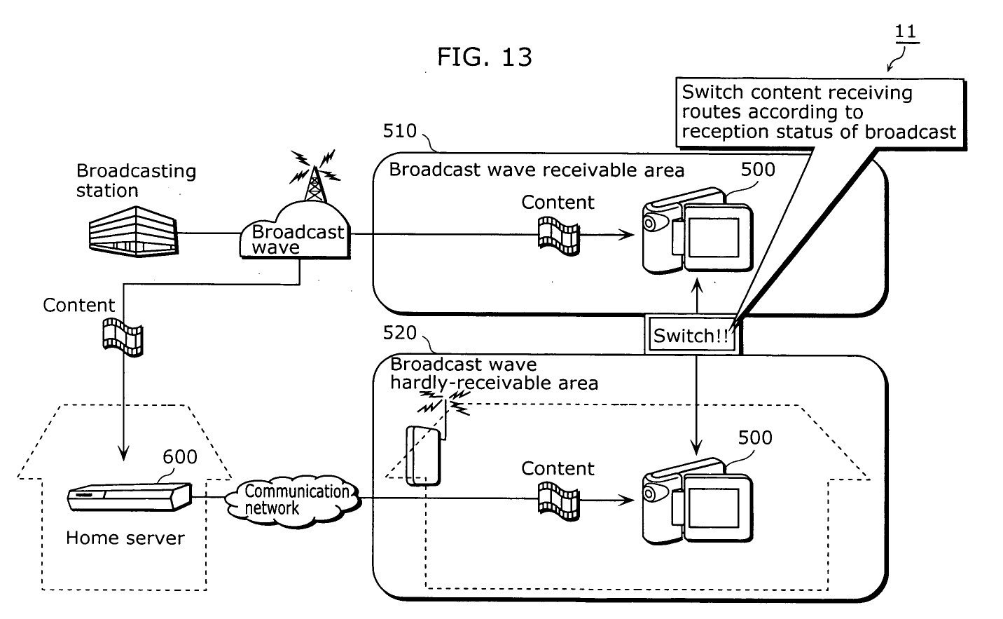

FIG. 13 is an external view of a content distributing system 11 in the embodiment. As to the same functional elements as the content distributing system 10 in the first embodiment, a description of these is omitted, and the additional functional elements in this embodiment are described in detail.

As shown in FIG. 13, the content distributing system 11 allows the receiving of content via a communication network 30 of a wireless LAN and the like from a home server 600 when the user moves from a broadcast wave receivable area 510 to a broadcast wave hardly-receivable area 520. In this case, the home server 600 receives content (stores the content when necessary) via a broadcast wave, converts the content to be used for a user terminal 500, and transmits the converted content to the user terminal 500 via the communication network 30.

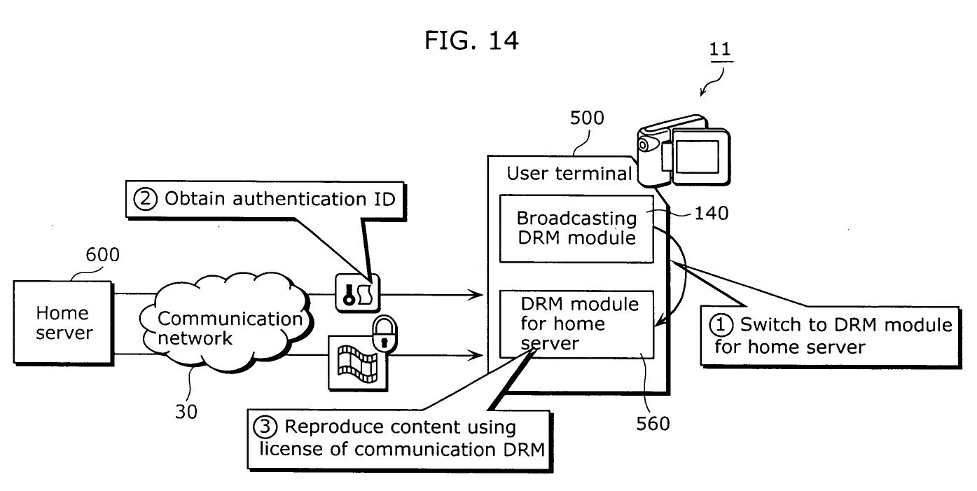

FIG. 14 is a diagram showing a general outline of the content distributing system 11 in the embodiment. As shown in FIG. 14, the user terminal 500 in the content distributing system 11 has a new DRM module for home servers 560 so as to obtain content and the decryption key of the content from the home server 600 via the communication network 30. Accordingly, the user terminal 500 can switch content receiving routes from a broadcast wave to a communication network 30 via the home server 600 so as to obtain a license and the decryption key of the license, and then the user terminal 500 can decrypt content using this decryption key and reproduce it. More specifically, the user terminal 500 (1) switches from a DRM module 140 for a broadcast wave to a DRM module 560 for the home server if the reception level of a broadcast wave falls to a certain level or below. Moreover, the user terminal 500 (2) performs mutual authentication with the home server 600. Additionally, the user terminal 500 is described as a device which performs mutual authentication with the home server 600. However, as the mutual authentication is not always necessary, either of the user terminal 500 and the home server 600 may authenticate the other. If the mutual authentication normally ends, the user terminal 100 (3) obtains content and its decryption key from the home server 600 via the communication network 30, and decrypts the content by using the obtained decryption key.

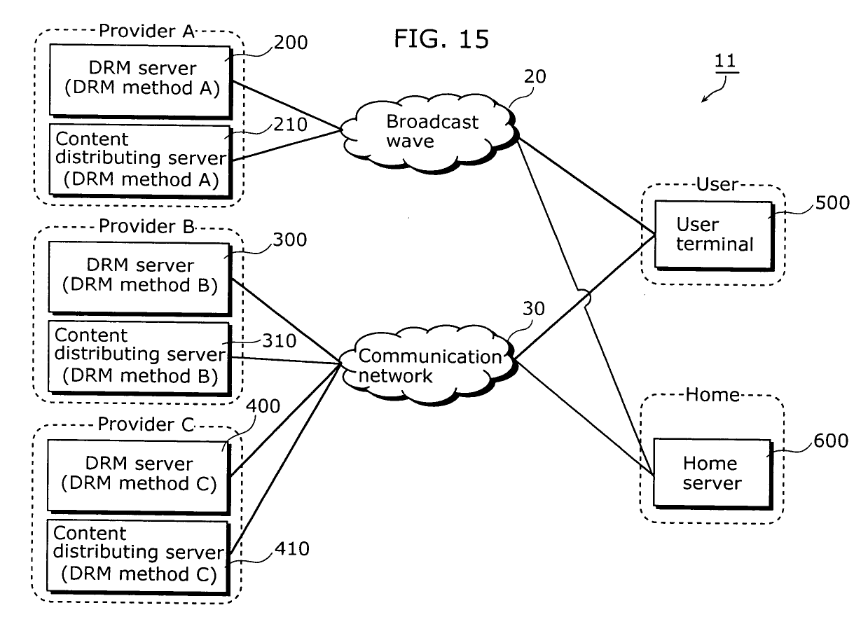

FIG. 15 is a block diagram showing a distributing form of content in the content distributing system 11 according to the embodiment. As shown in FIG. 15, the user terminal 500 in the content distributing system 11 obtains (receives) a license and content from a DRM server 200 and a content distributing server 210 of a provider A via a broadcast wave 20. On the other hand, the home server 600 obtains (receives) a license and content from the DRM server 200 and the content distributing server 210 of provider

A via the broadcast wave 20. The home server 600 also converts and encrypts the obtained content into a format for transmission to the user terminal 500, and transmits the converted and encrypted content and its decryption key to the user terminal 500 via the communication network 30. Accordingly, the user terminal 500 can receive the same content from the home server 600 via the communication network 30 even if it becomes difficult to receive content via the broadcast wave 20 while the terminal is moving.

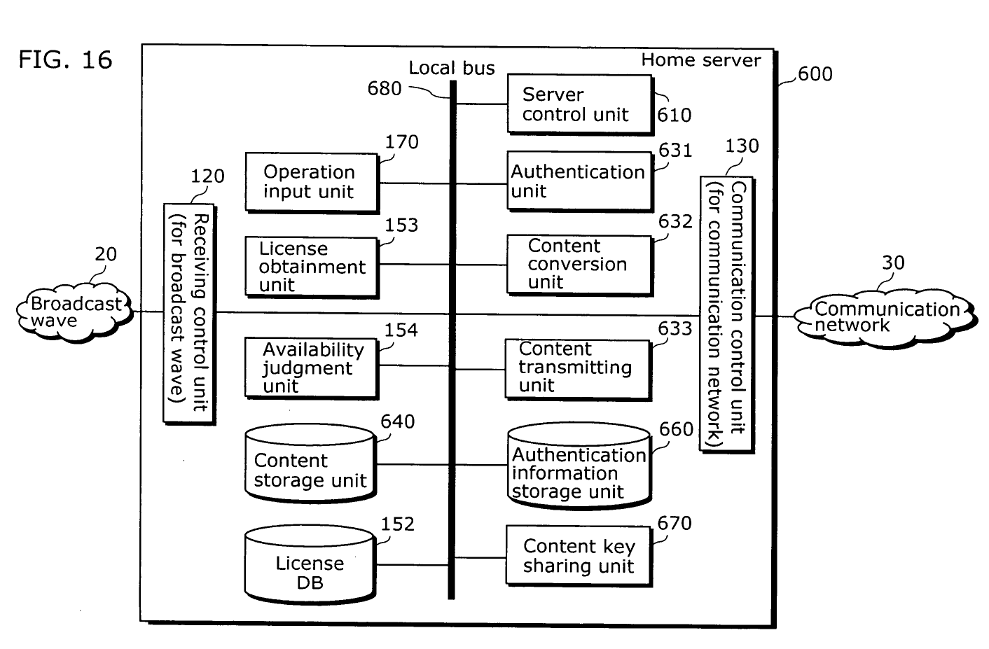

FIG. 16 is a block diagram showing the functional configuration of the home server 600 in the embodiment. As shown in FIG. 16, the home server 600 has a server control unit 610, a receiving control unit 120, a communication control unit 130, an operation input unit 170, a license obtainment unit 153, an availability judgment unit 154, an authentication unit 631, a content conversion unit 632, a content transmitting unit 633, a content storage unit 640, a license DB 152, an authentication information storage unit 660, and a content key sharing unit 670, each of which is connected by an local bus 680. Note that the same functional elements in the home server 600 as the user terminal 100 or the DRM module 150 in the first embodiment are provided with the same numerical references, and a description of these is omitted.

The server control unit 610 is configured with CPU including ROM, RAM and the like. The home server 600 is entirely controlled by causing the CPU to execute control programs stored in ROM and the like.

The authentication unit 631 performs mutual authentication between the home server 600 and the user terminal 500, or device authentication for the user terminal 500.

The content conversion unit 632 decrypts the content received via the receiving control unit 120 using a license stored in the license DB 152, and converts the decrypted content into a format for transmission to the user terminal 500. Additionally, the content conversion unit 632 performs an operation for encrypting the converted content using the key shared between the user terminal 500 and the content key sharing unit 670.

The content transmitting unit 633 controls transmission of content to the user terminal 500.

The content storage unit 640 is, for example, HD and DVD devices, and stores pre-decryption or post-decryption content which is received via the receiving control unit 120.

The authentication information storage unit 660 is a RAM or the like, and stores information necessary for mutual authentication between the home server 600 and the user terminal 500, or device authentication for the user terminal 500.

The content key sharing unit 670 holds the latest content key obtained via the license obtainment unit 153, and performs control for sharing the content key with the user terminal 500.

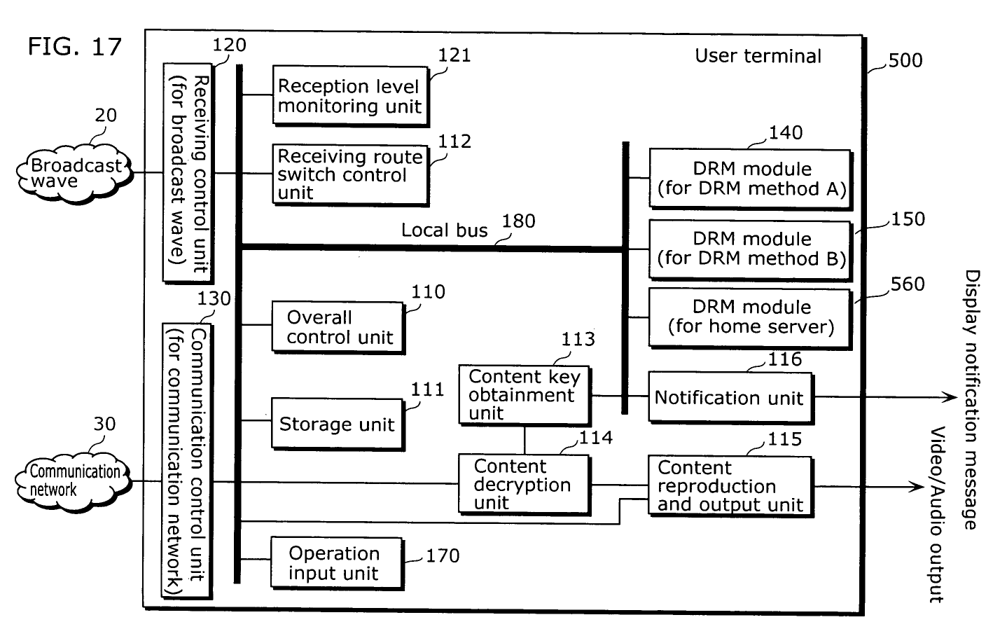

FIG. 17 is a block diagram showing the functional configuration of the user terminal 500 in the embodiment. The user terminal 500 has functions equivalent to those of the above-mentioned user terminal 100 except that it has the DRM module 560 instead of the DRM module 160 in the user terminal 100 of the first embodiment.

The DRM module 560 controls reception of content from the home server 600 via the communication network 30 such as a wireless LAN and the like when the user terminal 500 moves from the broadcast wave receivable area 510 to the broadcast wave hardly-receivable area 520.

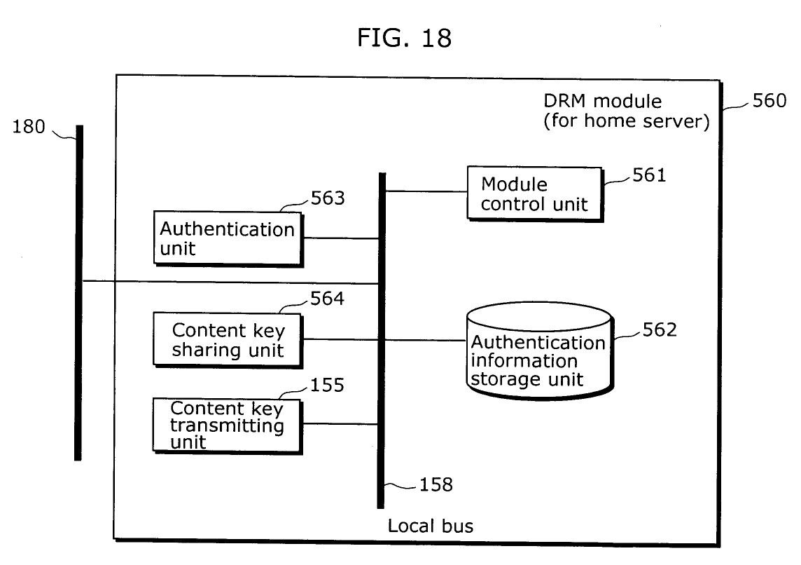

FIG. 18 is a block diagram showing the functional configuration of the above-mentioned DRM module 560. As shown in FIG. 18, the DRM module 560 has a module control unit 561, an authentication information storage unit 562, an authentication unit 563, a content key sharing unit 564, and a content key transmitting unit 155.

Note that the same functional elements in the DRM module 560 as the DRM module 150 in the first embodiment are provided with the same numerical references, and a description of these is omitted.

The module control unit 561 controls the entire DRM module 560 by an dedicated processor and the like.

The authentication information storage unit 562 is a RAM or the like, and stores necessary information for mutual authentication between the user terminal 500 and the home server 600.

The authentication unit 563 performs mutual authentication between the user terminal 500 and the home server 600.

The content key sharing unit 564 follows direction from the content key sharing unit 670, and performs control for sharing the content key between the home server 600 and the user terminal 500.

The operation of the user terminal 500 according to the embodiment is basically the same as the operation of the user terminal 100 according to the first embodiment. However, the user terminal 500 is different from the user terminal 100 in that the content distributing system 11 has the home server 600 between the broadcast wave 20 and the user terminal 500 which receives content via the communication network 30; and broadcast content is stored and the license of the content is controlled by the home server 600; and in that the control on the license is omitted if the user terminal 500 receives content from the home server 600.

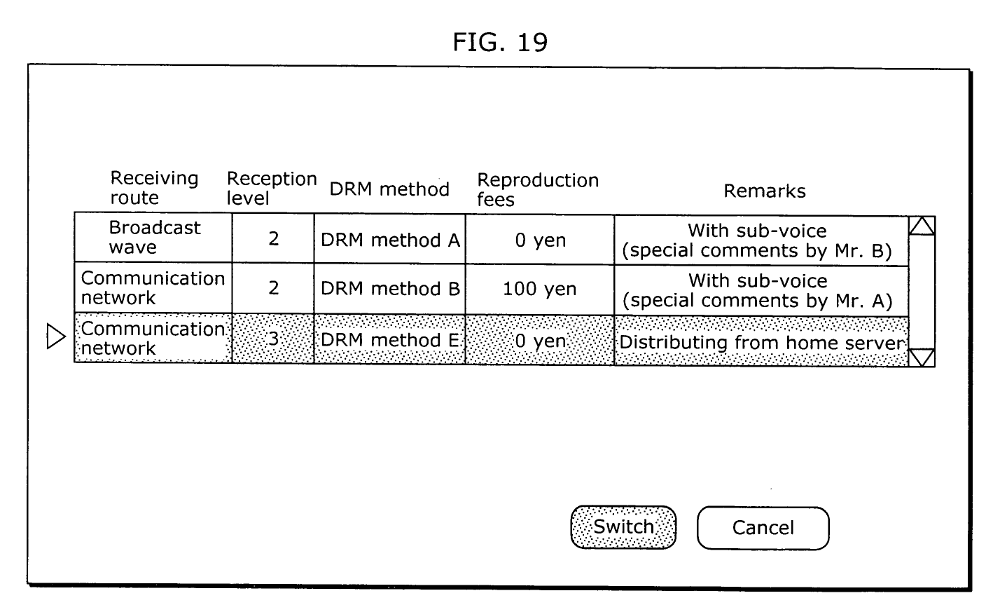

FIG. 19 is an example of display on the switch indication screen in the content reproduction and output unit 115 of the user terminal 500 according to the embodiment. Like in the first embodiment, the switch indication screen shown in FIG. 19 displays a list of receiving forms which is available for receiving content in the user terminal 500. Accordingly, the user can switch to a receiving route via the home server 600 in reference to a list of the switchable receiving routes.

Additionally, the respective configurations in the first, second and third embodiments include the content key obtainment unit 113, the content decryption unit 114, and the content reproduction and output unit 115 outside the DRM modules. However, configurations are not limited to these configurations, and each DRM module may include plural content obtainment unit 113, the content decryption unit 114, and the content reproduction and output unit 115 outside the DRM modules. In addition, these units may be included in each of the DRM modules.

The third embodiment shows that the home server 600 receives a license via a broadcast wave 20, but it may also receive a license via the communication network 30.

The third embodiment shows that the home server 600 performs the process on a license and the user terminal 500 receives a decryption key for the content encrypted by the home server 600. However, such processes on a license do not always need to be performed. The home server 600 may transmit content and a license to the user terminal 500, and cause the DRM module 560 of the user terminal 500 to perform the process on a license.

If the user terminal 500 cannot receive the broadcast wave 20, it may cause the home server 600 to record the content via the communication network 30.

### INDUSTRIAL APPLICABILITY

The present invention can be used in television broadcasting systems such as digital terrestrial television broadcasting and the like. In addition, the present invention can be used in network systems such as the Internet and the like which complement the above-mentioned television broadcasting system.

1. A content receiving apparatus including a first receiving unit which receives broadcast content via a broadcast wave and a second receiving unit which receives communication content identical to the broadcast content via a communication network, said apparatus comprising:
a first judgment unit operable to judge whether or not switching from said first receiving unit to said second receiving unit is appropriate;
an availability judgment unit operable to judge whether or not the communication content is available when the switching to said second receiving unit is performed; and
a receiving route switch unit operable to switch content receiving routes from said first receiving unit to said second receiving unit when said first judgment unit judges that the switching is appropriate and said availability judgment unit judges that the communication content is available.

2. The content receiving apparatus according to claim 1,
wherein said first judgment unit is operable to judge that the switching is appropriate when the electric field intensity of the broadcast wave falls to a certain level or below.

3. The content receiving apparatus according to claim 2,
wherein said first judgment unit is further operable to judge that the switching is appropriate when a usage fee of the communication content is lower than a usage fee of the broadcast content.

4. The content receiving apparatus according to claim 2,
wherein said first judgment unit is further operable to judge that the switching is appropriate when information which is different from information added to the broadcast content is added to the communication content.

5. The content receiving apparatus according to claim 1,
wherein said availability judgment unit is operable to judge that the switching is possible when a license compliant with the communication content is available.

6. The content receiving apparatus according to claim 1, further comprising
a holding unit operable to hold the license compliant with the communication content,
wherein said availability judgment unit is further operable to judge whether or not the license held by said holding unit is valid, and
said receiving route switch unit is operable to switch content receiving routes from said first receiving unit to said second receiving unit when said first unit judges that the switching is appropriate and said availability judgment unit judges that the communication content is available.

7. The content receiving unit according to claim 1, further comprising:
an information collection unit operable to collect pieces of information about the receiving of the communication content via the broadcast wave and the communication network;
an information presentation unit operable to present the collected information to a user; and
an operation acceptance unit operable to accept the selection of a piece of information among the presented pieces of information,
wherein said first judgment unit is operable to judge that the switching based on the accepted information is appropriate.

8. The content receiving apparatus according to claim 1,
wherein said first judgment unit is operable to make the judgment based on a termination time of the broadcast content, and
said receiving route switch unit is operable to switch the receiving routes using address information regarding a website included in the broadcast content, the website being connected to the communication network and providing the communication content.

9. The content receiving apparatus according to claim 1,
wherein said first receiving unit is operable to receive broadcast content encrypted by a first copyright protection method,
said second receiving unit is operable to receive communication content encrypted by a second copyright protection method, and
said receiving route switch unit is operable to switch the content receiving routes and the copyright protection methods from said first receiving unit to said second receiving unit when said first judgment unit judges that the switching is appropriate and said availability judgment unit judges that the communication content is available.

10. A content receiving method for a content receiving apparatus including a first receiving unit which receives broadcast content via a broadcast wave and a second receiving unit which receives communication content identical to the broadcast content via a communication network, said method comprising:
a first judging step of judging whether or not the switching from the first receiving unit to the second receiving unit is appropriate;
a judging step of judging whether or not the communication content is available when switching to the second receiving unit is performed; and
a switching step of switching content receiving routes from the first receiving unit to the second receiving unit when the switching is judged to be appropriate in said first judging step and the communication content is judged to be available in said availability judging step.

11. A program for a content receiving apparatus including a first receiving unit which receives broadcast content via a broadcast wave and a second receiving unit which receives communication content identical to the broadcast content via a communication network, said program causing a computer to execute:
a first judging step of judging whether or not the switching is from the first receiving unit to the second receiving unit is appropriate;
a judging step of judging whether or not the communication content is available when switching to the second receiving unit is performed; and
a switching step of switching content receiving routes from the first receiving unit to the second receiving unit when the switching is judged to be appropriate in said first judging step and the communication content is judged to be available in said availability judging step.

12. A content distributing system which includes a content transmitting apparatus and a content receiving apparatus, said system comprising:
said content transmitting apparatus which includes
a content transmitting unit operable to transmit information on broadcast content or communication content, and a license to a content receiving apparatus via a broadcast wave or a communication network, and
said content receiving apparatus which includes
a first receiving unit operable to receive broadcast content via a broadcast wave;
a second receiving unit operable to receive communication content identical to the broadcast content via a communication network;
a first judgment unit operable to judge whether or not switching from said first receiving unit to said second transmitting unit is appropriate;
an availability judgment unit operable to judge whether or not the communication content is available when switching to said second receiving unit is performed; and
a receiving route switch unit operable to switch content receiving routes from said first receiving unit to said second receiving unit when said first judgment unit judges that the switching is appropriate and said availability judgment unit judges that the content is available.
